(19) United States
(12) Patent Application Publication
(10) Pub. No.: US 2010/0004064 A1
(43) Pub. Date: Jan. 7, 2010

(54) UNIVERSAL JOINT

(76) Inventor: Hou-Fei Hu, Taichung (TW)

Correspondence Address: RABIN & Berdo, PC, 1101 14TH STREET, NW, SUITE 500, WASHINGTON, DC, 20005, US

(21) Appl. No.: 12/167,544

(22) Filed: Jul. 3, 2008

(51) Int. Cl. F16D 3/16

(52) U.S. Cl. 464/112

(57) ABSTRACT

A universal joint includes a base having a receiving recess and two holes defined through the base and communicating the receiving recess. A pivotal member includes a connection portion, a pivotal portion and a neck portion connected between the connection portion and the pivotal portion which is pivotably engaged with the receiving recess. A passage is defined through the pivotal portion and a pin extends through the two holes and the passage to pivotally connect the pivotal member to the base. The neck portion has a lowest point, and a shortest distance defined between the lowest point and a transverse line extending through an axial center line of the passage and perpendicular to the pivotal member is larger than a radius of the pivotal portion. The two respective distances between the lowest point and the transverse line extending through the axial center line of the passage and perpendicular to the pivotal member, and between the lowest point and the peripheral wall are longer so that the pivotal member can pivot larger angle and has better strength.

### BACKGROUND OF THE INVENTION

1. Field of the Invention

The present invention relates generally to a universal joint, and more particularly, to a universal joint which can be operated at a large angle and withstand high torque.

2. The Prior Art

FIG. 1 shows a conventional universal joint 1, which includes a base 2 and a pivotal member 3 pivotably engaged with the base 2. The pivotal member 3 comprises a connection end 4, a sphere 5 with a passage 6, a neck 7 connected between the connection end 4 and the sphere 5 and a pin 8 which extends through the base 2 and the passage 6. A distance L1 between a lowest point G1, which is located at a point where the neck 7 has the narrowest thickness, and a transverse line extending through a common axial center line of the sphere 5 and the passage 6 and perpendicular to the pivotal member 3, is shorter than the radius r1 of the sphere 5. The relationship of the L1 and r1 restricts the pivotal movement of the pivotal member 3, limiting the angle at which the tool can be used.

FIG. 2 shows another conventional universal joint 10 which is able to be operated with a large angular movement for the pivotal member. In order to achieve the greater working angle, the peripheral wall 11 of the base 10 is cut to be lowered and the neck 17 is made to be slim and elongate so that the distance L2 between the lowest point G2 and the axial center line of the passage 16 is shorter than the radius r2 of the sphere 15. The pivotal member 13 can pivot to a larger angle, but the neck 17 is easily cracked or damaged when a large torque is applied to the joint 10.

FIG. 3 shows that due to the lowered peripheral wall 11 of the base 10, when the pivotal member 13 pivots, the neck 17 and the sphere 15 cannot lean on the peripheral wall 11, and all of the torque is transferred to the pin 18 which is easily broken.

### SUMMARY OF THE INVENTION

The primary objective of the present invention is to provide a universal joint which overcomes the shortcomings of conventional universal joints that either cannot reach a large angle, or withstand lower torque because of the slim and thin neck.

The present invention provides a universal joint that includes a base having a receiving recess and two holes defined through a peripheral wall of the base and communicating the receiving recess. A pivotal member includes a connection portion and a pivotal portion on two ends and a neck portion connected between the connection portion and the pivotal portion. The pivotal portion is pivotably engaged with the receiving recess. A passage is defined through the pivotal portion, and a pin extends through the two holes and the passage to pivotally connect the pivotal member to the base. The neck portion has a lowest point, and a shortest distance defined between the lowest point and a transverse line extending through an axial center line of the passage and perpendicular to the pivotal member is larger than a radius of the pivotal portion.

The two respective distances between the lowest point, and the transverse line extending through the axial center line of the passage and perpendicular to the pivotal member, and between the lowest point and the peripheral wall of the base are longer so that the pivotal member can pivot to a larger angle and has better strength.

### BRIEF DESCRIPTION OF THE DRAWINGS

The present invention will be apparent to those skilled in the art by reading the following detailed description of a preferred embodiment thereof, with reference to the attached drawings, in which:

FIG. 1 shows a first conventional universal joint;

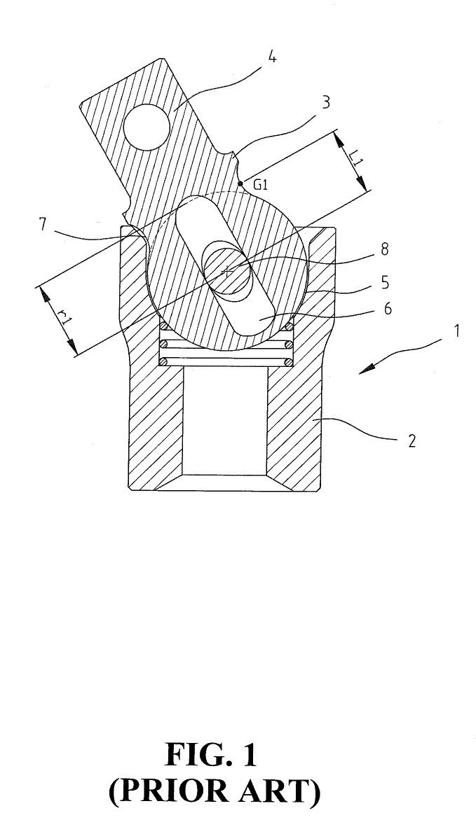

FIG. 2 shows a second conventional universal joint;

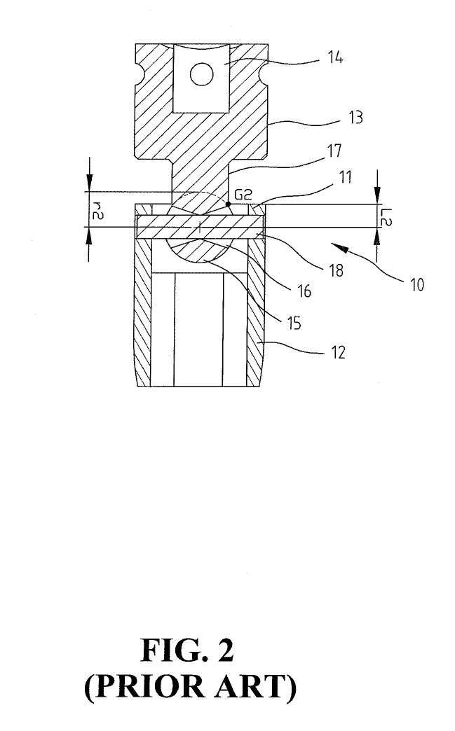

FIG. 3 shows a pivotal member pivoting relative to a base of the second conventional universal joint;

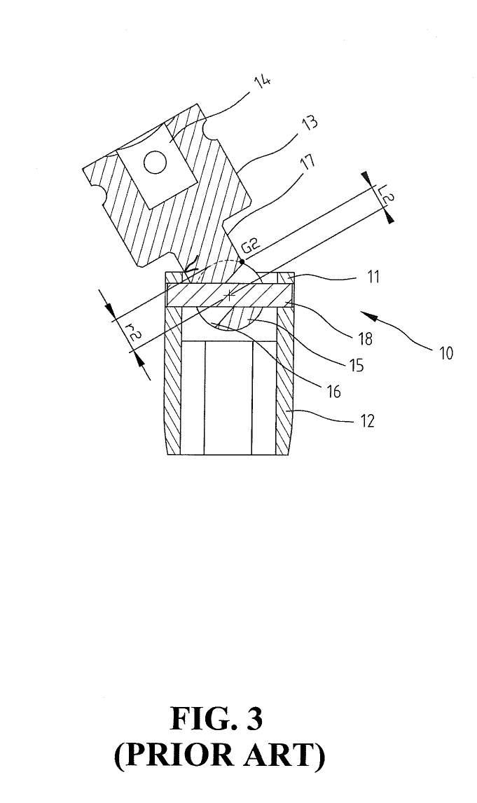

FIG. 4 is a perspective view to show a universal joint of the present invention;

FIG. 5 is an exploded view to show the universal joint of the present invention;

FIG. 6 is a cross sectional view taken along line 6-6 in FIG. 4;

FIG. 7 is a cross sectional view taken along line 7-7 in FIG. 4;

FIG. 8 is an exploded view of the universal joint according to a second embodiment of the present invention; and

FIG. 9 is a cross sectional view of the universal joint according to the second embodiment of the present invention.

### DETAILED DESCRIPTION OF THE PREFERRED EMBODIMENT

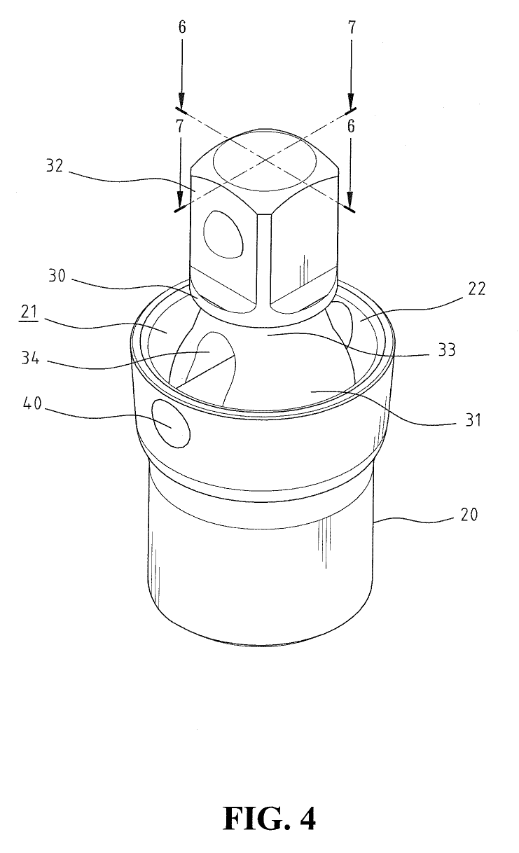

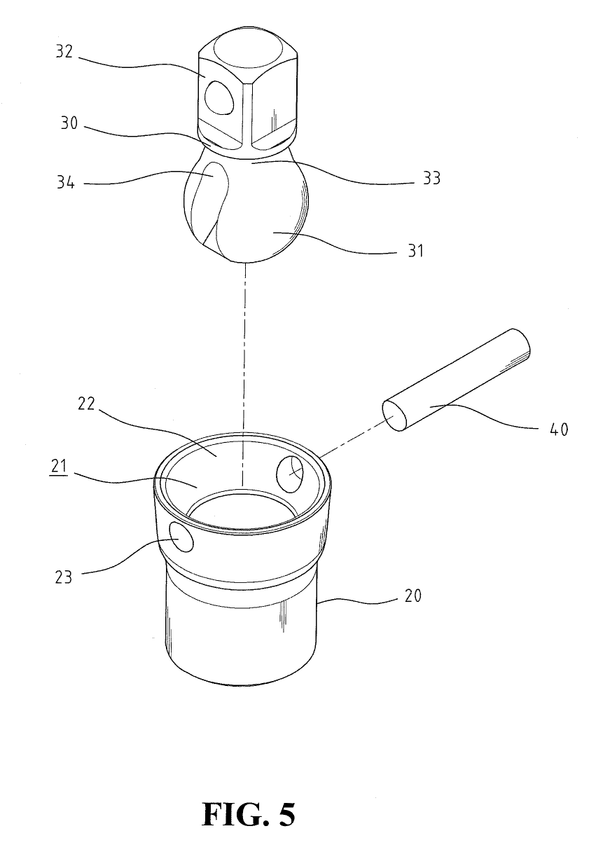

With reference to the drawings and in particular to FIGS. 4 and 5, a universal joint in accordance with a preferable embodiment of the present invention comprises a base 20 and a pivotal member 30, which is pivotably connected to the base 20.

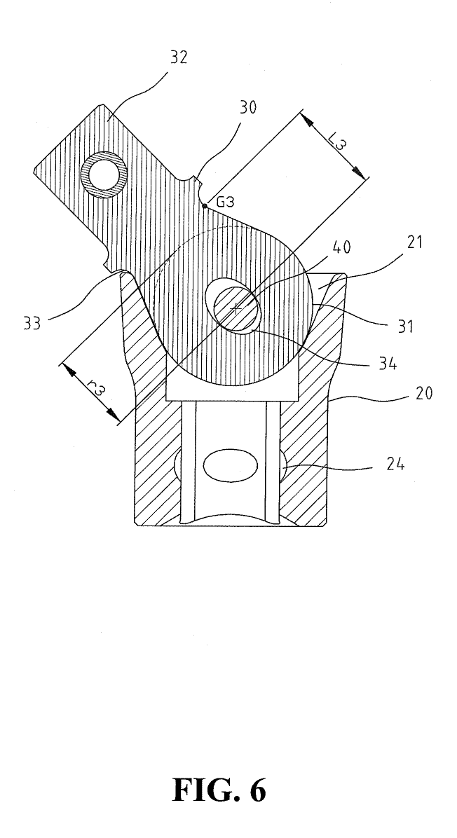

As shown in FIG. 6, the base 20 has a receiving recess 21 defined in a first end thereof, and the receiving recess 21 is defined by a peripheral wall 22. Two holes 23 are defined through the peripheral wall 22 of the base 20 and communicate the receiving recess 21. An engaging portion 24 is connected to a second end of the base 20 so as to be connected with a tool such as a wrench or driving tool.

The pivotal member 30 has a pivotal portion 31 and a connection portion 32 on two ends thereof, and a neck portion 33 is connected between the connection portion 32 and the pivotal portion 31. The pivotal portion 31 is pivotably engaged with the receiving recess 21, and a passage 34 is defined through the pivotal portion 31. A pin 40 extends through the two holes 23 and the passage 34 to pivotally connect the pivotal member 30 to the base 20, such that the pivotal member 30 is pivotable relative to the base 20. The passage 34 is a gradually convergent-divergent passage. The connection portion 32 is to be connected with driving tool such as socket.

FIG. 6 shows that the neck portion 33 has a lowest point G3, which locates at a point where the neck portion 33 has the narrowest thickness. A shortest distance L3 is defined between the lowest point G3 and a transverse line extending through an axial center line of the passage 34 and perpendicular to the pivotal member 30. A distance L4 is defined between a top edge of the peripheral wall 22 and the transverse line extending through the axial center line of the passage 34 and perpendicular to the base 20. The shortest distance L3 is larger than a radius r3 of the pivotal portion 31. Preferably, L3/r3>1.1, and L3/L4>1.3. The two respective distances between the lowest point G3 and the axial center line of the passage 34 and between the lowest point G3 and the peripheral wall 22 are longer so that the pivotal member 30 can pivot to a larger angle and has better strength.

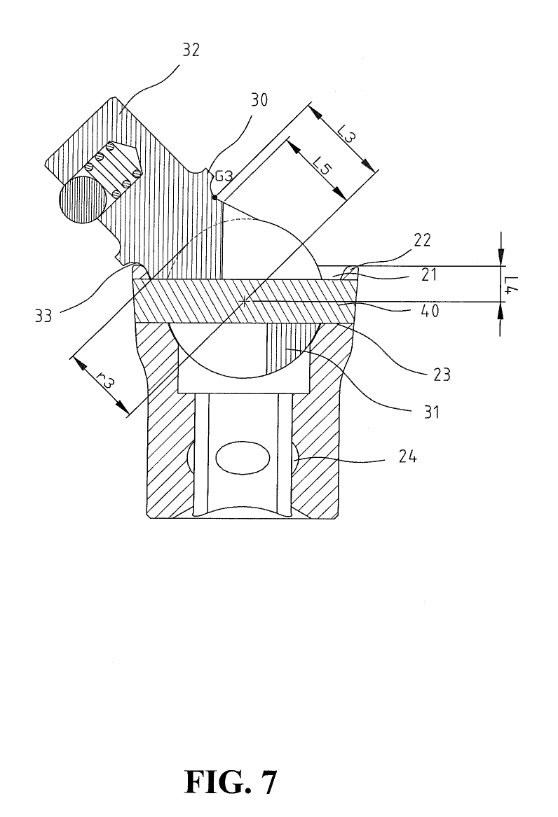

FIG. 7 shows that a longest distance L5 is defined between a maximum outer end of the passage 34 and the transverse line extending through the axial center line of the passage 34 and perpendicular to the pivotal member 30. The longest distance L5 is not larger than the shortest distance L3. By this arrangement, the pivotal member 30 has better structural strength when it pivots to a large angle and can bear larger torque.

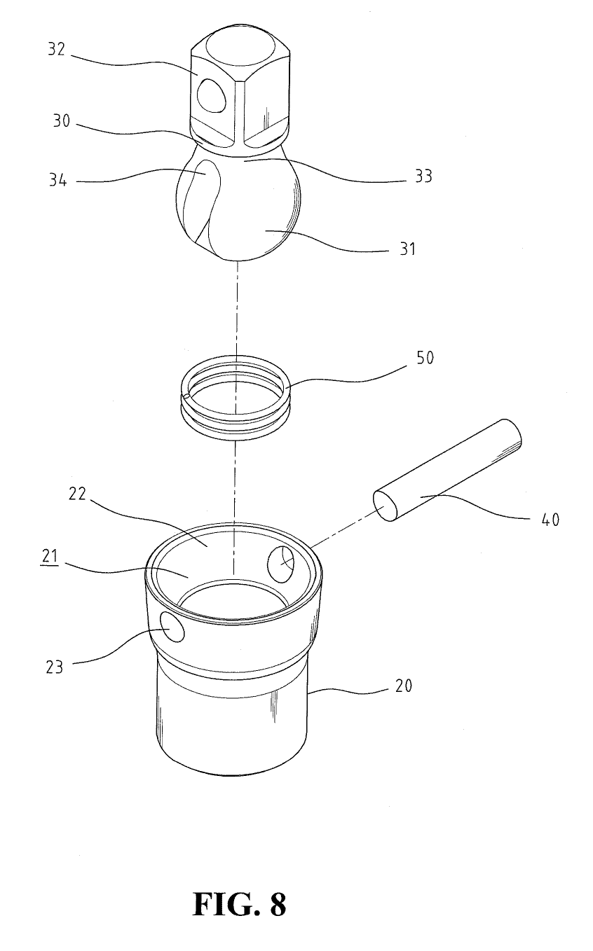

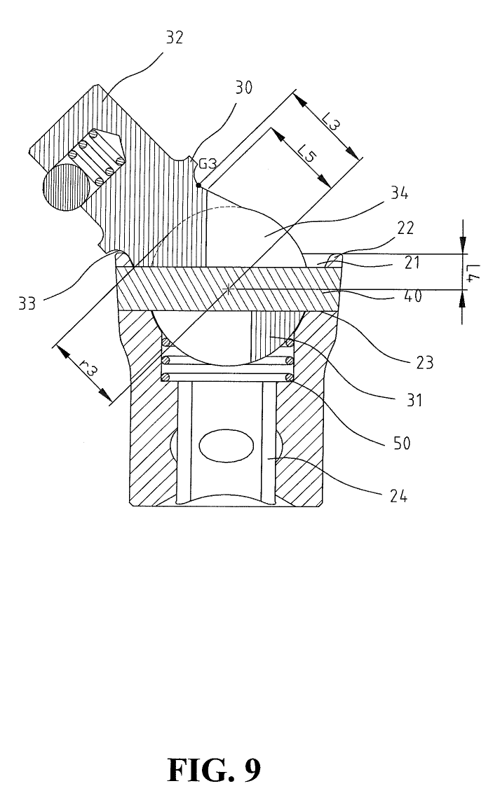

FIGS. 8 and 9 show a universal joint in accordance with a second embodiment of the present invention, in which a spring 50 is further provided in the receiving recess 21 and biases against the pivotal portion 31 of the pivotal member 30. By the spring 50, the pivotal member 30 is operated smoothly and does not shake during operation.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A universal joint, comprising:
a base having a receiving recess defined in a first end thereof and two holes defined through the base and communicating the receiving recess;
a pivotal member having a connection portion formed on one end thereof, a pivotal portion formed on the other end thereof and a neck portion connected between the connection portion and the pivotal portion, the pivotal portion pivotably engaged with the receiving recess, and a passage defined through the pivotal portion, a pin extending through the two holes of the base and the passage of the pivotal portion to pivotally connect the pivotal member to the base, the neck portion having a lowest point G3, and a shortest distance L3 defined between the lowest point G3 and a transverse line extending through an axial center line of the passage and perpendicular to the pivotal member, being larger than a radius of the pivotal portion.

2. The universal joint as claimed in claim 1, wherein a quotient of the shortest distance L3 and the radius r3 is larger than 1.1.

3. The universal joint as claimed in claim 1, wherein the receiving recess is defined by a peripheral wall of the base, and the two holes are defined through the peripheral wall.

4. The universal joint as claimed in claim 1, wherein the passage passes through a center of the pivotal portion.

5. The universal joint as claimed in claim 1, wherein an axial center line of the passage is an axial center line of the pin.

6. The universal joint as claimed in claim 1, wherein an engaging portion is connected to a second end of the base.

7. The universal joint as claimed in claim 1, wherein the passage is a gradually convergent-divergent passage.

8. The universal joint as claimed in claim 7, wherein the passage includes a maximum outer end and a longest distance L5 is defined between the maximum outer end and the transverse line extending through the axial center line of the passage and perpendicular to the pivotal member, the longest distance L5 is not larger than the shortest distance L3.

9. The universal joint as claimed in claim 3, wherein a distance is defined between a top edge of the peripheral wall and the transverse line extending through the axial center line of the passage and perpendicular to the base, a quotient of the shortest distance L3 and the distance between the top edge of the peripheral wall and the axial center line of the passage is larger than 1.3.

10. The universal joint as claimed in claim 1, wherein the pivotal portion is substantially a sphere.

11. The universal joint as claimed in claim 1, wherein the connection portion of the pivotal member is adapted to be connected with a tool.

12. The universal joint as claimed in claim 1, wherein the lowest point G3 locates at a point where the neck portion has the narrowest thickness.

13. The universal joint as claimed in claim 1, wherein a spring is received in the receiving recess and biases against the pivotal portion of the pivotal member.

14. A universal joint, comprising:
a base having a receiving recess defined in a first end thereof, and a pivotal member having a connection portion formed on one end, a pivotal portion formed on the other end and a neck portion connected between the connection portion and the pivotal portion, the pivotal portion pivotably engaged with the receiving recess, the connection portion having a lowest point G3 and a shortest distance L3 being defined between the lowest point G3 and a transverse line extending through an axial center line of the pivotal portion and perpendicular to the pivotal member, a quotient of the shortest distance L3 and a radius r3 of the pivotal portion being larger than 1.1.

15. The universal joint as claimed in claim 14, wherein the lowest point G3 locates at a point where the neck portion has the narrowest thickness.

16. The universal joint as claimed in claim 14, wherein the receiving recess is defined by a peripheral wall of the base and a distance L4 is defined between a top edge of the peripheral wall and the transverse line extending through the axial center line of the pivotal portion and perpendicular to the base, a quotient between the shortest distance L3 and the distance L4 is larger than 1.3.
